(19) United States
(12) Patent Application Publication
(10) Pub. No.: US 2024/0380937 A1
(43) Pub. Date: Nov. 14, 2024

(54) Electronic Devices and Corresponding Methods for Identifying a Content Presentation Companion Device Gaming Mode of Operation

(71) Applicant: Motorola Mobility LLC, Chicago, IL (US)

(72) Inventors: Amit Kumar Agrawal, Bangalore (IN); Satyabrata Rout, Bhubaneswar (IN); Igor Kovalenko, Palantine, IL (US)

(21) Appl. No.: 18/195,227

(22) Filed: May 9, 2023

(51) Int. Cl. H04N 21/41; H04N 21/478; H04N 21/488

(52) U.S. Cl. CPC H04N 21/41265; H04N 21/4108; H04N 21/43615; H04N 21/4781; H04N 21/4882

(57) ABSTRACT

An electronic device includes a communication device and a user interface. The communication device detects establishment of wireless electrical communication channel to a content presentation companion device. One or more processors of the electronic device, optionally in response to a gaming application operating on the one or more processors, causes the communication device to query the content presentation companion device to determine whether the content presentation companion device supports a gaming mode of operation.

### BACKGROUND

### Technical Field

This disclosure relates generally to electronic devices having communication circuits, and more particularly to electronic devices engaged in the transmission of signals supplied in digital form, including data transmission and telegraphic communication, with a content presentation companion device.

### Background Art

The advanced processing power available in modern electronic communication devices, examples of which include smartphones, tablet computers, and laptop computers, enable voice and video communications between people. Additionally, such devices can also engage in videoconferences, stream content such as movies, videos, and television shows, play music, and offer other forms of entertainment. In addition to being tools for communicating with friends, family, and work colleagues, these devices are also real-time multimedia content entertainment devices.

Some electronic devices are equipped with a content redirection feature that allows this multimedia content to stream through a first device, such as a smartphone, and then to be redirected to a second device having a larger display. While this makes events such as movies, television shows, and videoconferences easier to see, it also allows a content presentation companion device having a larger display serve as the primary display for the electronic device itself. While a neat feature, ensuring that a companion device is optimally configured for a given usage situation can be difficult. It would be advantageous to have electronic devices and systems that make this process simpler.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates one explanatory electronic device in accordance with one or more embodiments of the disclosure.

FIG. 3 illustrates one explanatory content presentation companion device in accordance with one or more embodiments of the disclosure.

FIG. 4 illustrates one explanatory method in accordance with one or more embodiments of the disclosure.

FIG. 5 illustrates one or more embodiments explanatory method steps in accordance with one or more embodiments of the disclosure.

FIG. 6 illustrates one or more embodiments explanatory method steps in accordance with one or more embodiments of the disclosure.

FIG. 7 illustrates one or more embodiments explanatory method steps in accordance with one or more embodiments of the disclosure.

FIG. 8 illustrates one or more embodiments explanatory method steps in accordance with one or more embodiments of the disclosure.

FIG. 9 illustrates one or more embodiments explanatory method steps in accordance with one or more embodiments of the disclosure.

FIG. 10 illustrates various embodiments of the disclosure.

FIG. 11 illustrates a prior art extended display identification data (EDID) file structure.

FIG. 12 illustrates one explanatory EDID extension block of data in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to causing, in response to a gaming application operating on one or more processors of an electronic device while a communication device is communicating with a content presentation companion device across a wireless electrical communication channel, the communication device to query the content presentation companion device to determine whether the content presentation companion device supports a gaming mode of operation. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of querying a content presentation companion device for an identification of operating modes and, where the content presentation companion device supports a gaming mode of operation, one or both of causing the content presentation companion device to transition to the gaming mode of operation and/or presenting indicia on a user interface identifying that the content presentation companion device supports the gaming mode of operation so a user can enable the gaming mode of operation at the content presentation companion device. The non-processor circuits may include, but are not limited to, a radio receiver, a radio transmitter, signal drivers, clock circuits, power source circuits, and user input devices.

As such, these functions may be interpreted as steps of a method to perform identifying operating modes of a content presentation companion device with which a wireless communication device is electronically communicating when a gaming application is operating on one or more processors of an electronic device and determining whether the operating modes include a gaming mode of operation, and causing a user interface of the electronic device to present indicia indicating that the content presentation companion device supports a gaming mode of operation. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, some modern portable electronic devices are equipped with a content redirection feature. Using smartphones manufactured by Motorola Mobility.sup.™ as one illustrative example, some models are equipped with their Ready For.sup.™, which is a feature that allows the Ready For.sup.™ device to connect to a content presentation companion device such as a larger monitor, television, or other device having a larger screen. Using the Ready For.sup.™ feature, users can wirelessly stream video content to the larger display of a content presentation companion device with no loss in performance. Illustrating by example, resolution of the images on the content presentation companion device is up to 4K with a frame rate that presents content without flicker or distortion.

While the Ready For.sup.™ feature does not require a cable or a docking station, many electronic devices do require a physical connection between the electronic device and the content presentation companion device for a content redirection feature to work properly. To wit, many standards such as the highly popular and ubiquitous high-definition multimedia interface (HDMI) interface standard require a physical wire be connected between a source device and a display device for content redirection to work. Additionally, even some users of advanced content redirection technologies such as Ready For.sup.™ even prefer to use a docking station and/or physical cable to couple their electronic device to a content presentation companion device because a physical cable defining a display data channel invariably offers a more reliable and faster data connection than do most wireless connections. Indeed, coupling a smartphone having Ready For.sup.™ capability to a monitor having a defined display size is a quite popular way to view content on a larger display.

Such is not the case, however, when a gaming application is operating on one or more processors of the electronic device. Many users prefer wireless electrical communication channels for communication between their smartphone, for example, and a larger monitor. This is true because the smartphone, where the gaming application is running, is frequently used as a control device. User actuation targets used to control the game are often presented on the display of the smartphone, while all the characters and action are presented on the content presentation companion device. When a wire is connected between the smartphone and the content presentation companion device, this limits a user's motion and agility.

This inhibition can compromise performance in the game. Using a snowboarding gaming application as an illustrative example where user actuation targets to control the boarder are presented on a smartphone while the boarder himself is presented on a content presentation companion device, having a wireless connection between the content presentation companion device and the smartphone can be the difference between allow a gamer to control the boarder to stomp the landing of a booter and a true wipeout that becomes either a taco a yard sale.

Thus, while wireless connections are preferred, when an electronic device is electronically communicating with a content presentation companion device using a wireless electrical communication channel, it can be difficult to ensure that the content presentation companion device is properly configured for a particular experience. Many content presentation companion devices offer multiple operating modes. Examples of these operating modes include a standard mode used for watching movies and television shows and a “gaming” or “low-latency mode” that reduces the latency between source device and content presentation companion device with respect to how presented content is refreshed on the display of the content presentation companion device. When a content presentation companion device is operating in a gaming or low-latency mode of operation, there is a much quicker response on the display of the content presentation companion device in response to the actuation of user actuation targets on the electronic device. This allows for a richer and better performance when a gaming application is operating on an electronic device that is using a content presentation companion device as a primary display for the electronic device. Without the gaming mode of operation, the gaming experience using a content presentation companion device can be choppy and disjointed.

At the same time, it is not desirable to have the gaming mode of operation enabled all the time. When watching a movie or television show, having the gaming mode of operation enabled can change other performance characteristics of the content presentation companion device. For this reason, the default mode of operation for most content presentation companion devices is the normal mode of operation. Indeed, many people are not even aware that their monitor supports a gaming mode of operation. Even if they are aware that a gaming mode of operation is supported, they frequently forget to enable it when playing a game on another electronic device while using the monitor as a content presentation companion device.

Embodiments of the disclosure provide a solution to this problem. In one or more embodiments, an electronic device includes a communication device and one or more processors operable with the communication device. When the communication device detects establishment of a wireless electrical communication channel with a content presentation companion device, the one or more processors cause the communication device to query the content presentation companion device to determine whether the content presentation companion device supports a gaming mode of operation.

In one or more embodiments, the one or more processors determine whether the content presentation companion device supports a gaming mode of operation by extracting operating modes of the content presentation companion device from an extension of EDID received by the content presentation companion device from the content presentation companion device in response to the query. Alternatively, the one or more processors determine whether the content presentation companion device supports a gaming mode of operation by parsing a product identification code from EDID received by the communication device from the content presentation companion device in response to the query. The one or more processors can parse the product identification code by transmitting a gaming mode of operation query comprising the product identification code to a remote electronic device. The remote electronic device can then send response comprising the operating modes of the content presentation companion device.

When the one or more processors determine that a content presentation companion device that is electronically communicating across a wireless electrical communication channel while a gaming application is operating on one or more processors of the electronic device, the one or more processors can cause a user interface of the electronic device to indicate that the content presentation companion device supports the gaming mode of operation. Illustrating by example, the one or more processors can cause the user interface to present a prompt saying something like, “The monitor you're using supports a gaming mode of operation. Your boarder could probably catch some sicker air and shred the gnar on his tray crisscrossing the cords if you turned it on.” Alternatively, so as not to disrupt the gaming application (which is again a snowboarding game in this illustration), the one or more processors of the electronic device could cause an audio user interface to indicate whether the content presentation companion device supports the gaming mode of operation by delivering an audible announcement with the same message.

In addition to notifying the user that the content presentation companion device electronically communicating with the electronic device supports a gaming mode of operation, in one or more embodiments the one or more processors can instruct the user to change the mode of operation of the content presentation companion device to the gaming mode of operation. Illustrating by example, where the one or more processors present the prompt on the display of the electronic device (or the content presentation companion device for that matter), the prompt may instruct that an operating mode of the content presentation companion device be changed to the gaming mode of operation.

In some embodiments, this transition of the content presentation companion device from the normal mode of operation to the gaming mode of operation can occur automatically. Illustrating by example, the prompt may ask the user, “do you want to change the content presentation companion device to the gaming mode of operation so your boarder can better carve the pow?” In one or more embodiments, when the display presenting the prompt receives user input interacting with the prompt, the one or more processors, in response to the user input, cause the communication device to transmit an instruction to the content presentation companion device over the wireless electrical communication channel instructing the content presentation companion device to transition to the gaming mode of operation.

In other embodiments, to provide the user with a more seamless experience, the electronic device simply does this upon determining that the content presentation companion device supports the gaming mode of operation. In one or more embodiments, the one or more processors automatically cause the communication device to transmit an instruction to the content presentation companion device over the wireless electrical communication channel instructing the content presentation companion device to transition to the gaming mode of operation in response to determining the content presentation companion device supports the gaming mode of operation.

In still other embodiments, the one or more processors can let the user simply know that content presentation companion devices supporting a gaming mode of operation exist. Illustrating by example, in one or more embodiments when the one or more processors fail to determine whether the content presentation companion device supports a gaming mode of operation in response to the query, the one or more processors cause the user interface of the electronic device to present indicia indicating that gaming modes of operation exist. The indicia may instruct investigation regarding whether the content presentation companion device currently being used supports such a mode, since it would be superior in allowing the person to more successfully crush booters on the slopes.

Advantageously, embodiments of the disclosure allow for either the automatic enablement of a gaming mode of operation or the ability to alert a person to the fact that their content presentation companion device supports a gaming mode of operation for a better gaming experience across a wireless electrical communication channel. While recent generations of the HDMI standard can enable an automatic low-latency mode, these standards are inapplicable to wireless electrical communication channels. Embodiments of the disclosure contemplate that it is difficult to discern, when two devices are communicating on a wireless electrical communication channel, whether a content presentation companion device supports a gaming mode of operation or not. Embodiments of the disclosure advantageously facilitate this determination by using an extension of EDID to inform the electronic device supplying the gaming content that a gaming mode of operation is supported. Moreover, embodiments of the disclosure allow for automatically enabling the gaming mode of operation is some embodiments, which is in contrast to the requirement that automatic low-latency modes of the HDMI standard must be manually enabled.

In some embodiments, the query to determine whether a content presentation companion device is used only when the content presentation companion device is a television. Embodiments of the disclosure contemplate that many monitors (defined as having a display of less than forty-three inches and a wired interface for coupling to a companion device) will use the HDMI standard since they are coupled to any source device by a wire. Conversely, large televisions (defined as having wireless connection capabilities and displays over forty-three inches) will support a gaming mode of operation but require manual actuation thereof. Consequently, in some embodiments, the query regarding whether a content presentation companion device supports a gaming mode of operation only occurs when the content presentation companion device is a large television.

Advantageously, embodiments of the disclosure determine whether a content presentation companion device supports a gaming mode of operation when electronic device is connected to a content presentation companion device with a wireless electrical communication channel. In one or more embodiments, the electronic device then presents on a display (or via audio) an identification of this determination. Other advantages will be described below. Others will be obvious to those of ordinary skill in the art having the benefit of this disclosure.

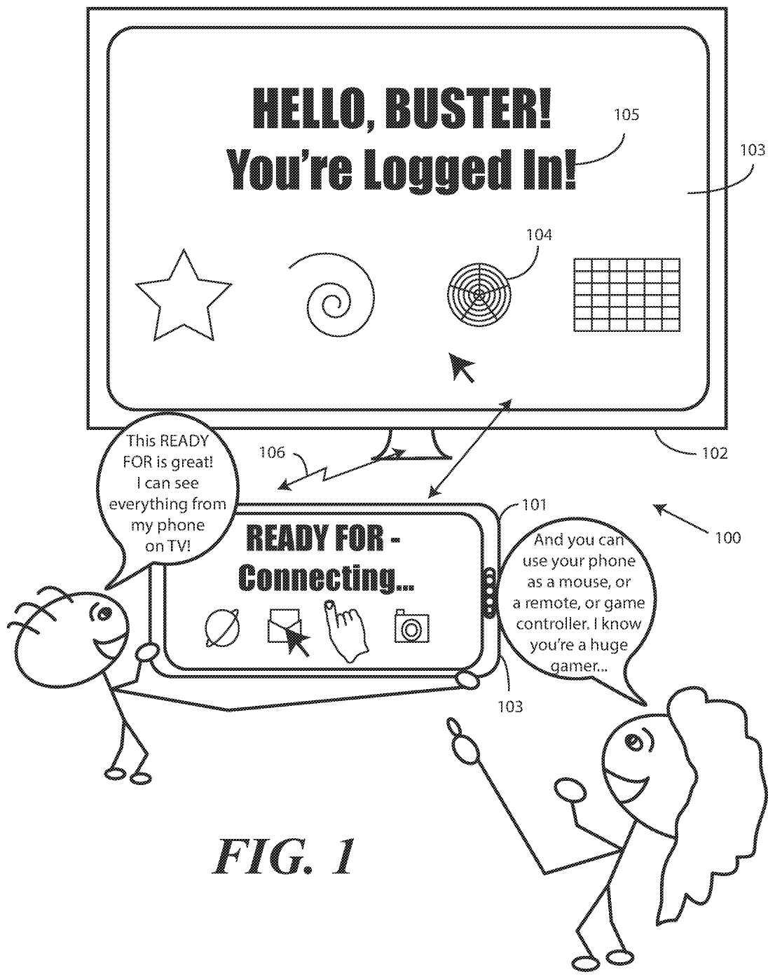

Turning now to FIG. 1, illustrated therein is one explanatory system 100 configured in accordance with one or more embodiments of the disclosure illustrating an electronic device 101 operating in conjunction with a content presentation companion device 102 in accordance with one or more embodiments of the disclosure. In FIG. 1, the electronic device 101 and the content presentation companion device 102 operate in tandem as a system, with the electronic device 101 providing the processing power to generate and/or receive content that could be presented on the display of the electronic device 101, but that is instead redirected for presentation on the content presentation companion device 102 while the content presentation companion device 102 serves as the primary display device for the electronic device 101.

As shown in FIG. 1, the electronic device 101 is electronically in communication with the content presentation companion device 102 using a wireless electrical communication channel 106. When the electronic device 101 is electronically in communication with the content presentation companion device 102, this allows the electronic device 101 to use the larger display 103 of the content presentation companion device 102 to present content. Illustrating by example, in one or more embodiments the electronic device 101 can operate in a “content redirection” mode by presenting content such as movies, videos, images, and even a traditional computer user interface, that are generated or received by the electronic device 101 and are redirected to the display 103 of the content presentation companion device 102. When a gaming application is operating on one or more processors of the electronic device 101, the content redirection mode can allow the electronic device 101 to serve as a gaming controller while characters, scenes, events, and other characteristics of the game are presented on the display 103 of the content presentation companion device 102.

Embodiments of the disclosure contemplate that with the advanced computing power available in smartphones and other electronic devices, users often play games and consume movies, videos, television shows, and other content using these devices. Additionally, they can perform work operations such as sending email, managing files, working on documents and spreadsheets, and so forth. By establishing a wireless electrical communication channel 106 between the electronic device 101 and the content presentation companion device 102, the processing power of the electronic device 101 can be leveraged to deliver this content to the content presentation companion device 102 for presentation of that content on the display 103 of the content presentation companion device 102. This allows a user to watch television, play video games, work on homework or office work, video call friends and family, or perform other tasks using the one or more processors of the electronic device 101 combined with the large display 103 of the content presentation companion device 102.

Using a content redirection feature, a small electronic device 101 such as the smartphone shown in FIG. 1 can connect to connect to a content presentation companion device 102 such as a larger monitor, television, or other device having a larger screen. Using the content redirection feature, users can wirelessly stream video, gaming, or other content from the electronic device 101 to the larger display 103 of the content presentation companion device 102 with no loss in performance. Resolution of the images 104 on the content presentation companion device 102 can be as high as 4K with frame rates that present the content 105 without flicker or distortion. In the illustrative embodiment of FIG. 1, neither a cable nor a docking station is required to use the content redirection feature since communication occurs across a wireless electrical communication channel 106.

When using the content redirection feature, the electronic device 101 can function as a mouse, trackpad, gaming controller, or other control device while the content 105 is being presented on the content presentation companion device 102. The content redirection feature can be used for presenting games, pictures, videos, television shows, or movies on the larger display 103 of a content presentation companion device 102 while a controller user interface used to control the content is presented locally on the display of the electronic device 101. Additionally, the controller user interface presented on the electronic device 101 can be used to control gaming applications, video conferences, and other content presentation tasks.

Embodiments of the disclosure advantageously provide a more intelligent system that dynamically enhances the feature set offered by the electronic device 101 by causing the electronic device 101 to deliver content to the content presentation companion device 102 while at the same time serving as a controller for the content presentation companion device 102. When a controller user interface is presented on the display of the electronic device 101, a user can deliver user input to the controller user interface to control the content being presented on the content presentation companion device 102. For instance, in one or more embodiments a user interface feature being presented on the content presentation companion device 102 can be adjusted using a controller user interface that is presented on a display of the electronic device 101.

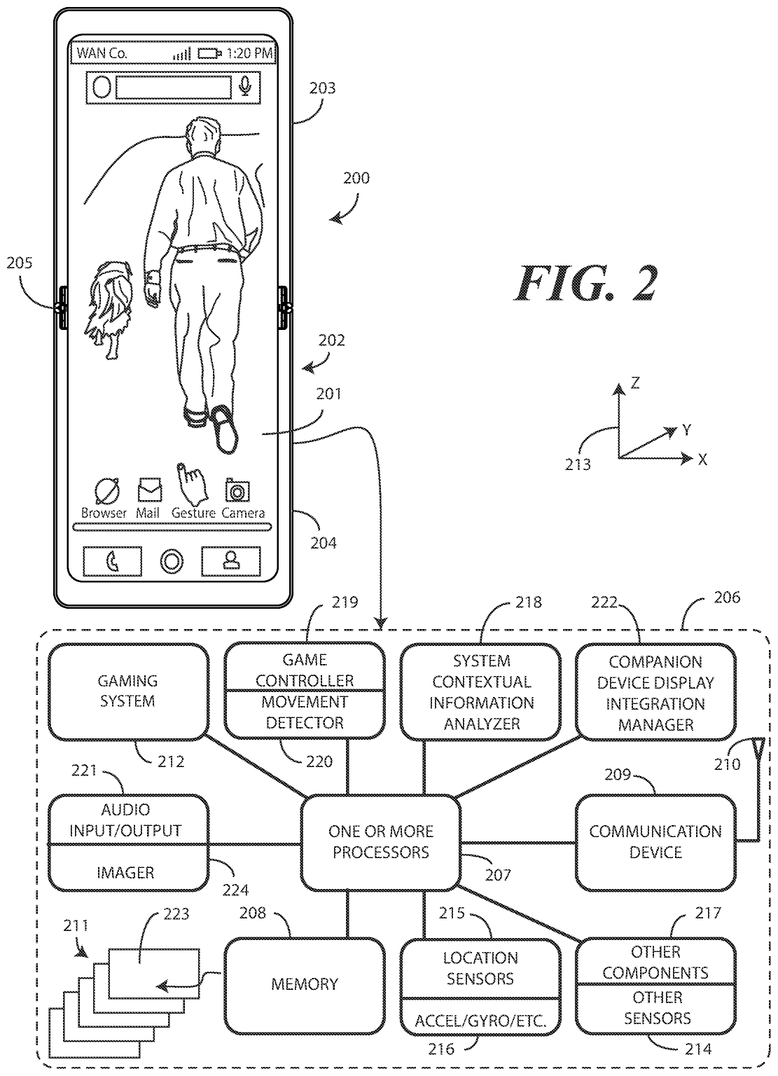

Before turning to the user interface enhancements and how they operate, a deeper look into the hardware of the electronic device 101 and the content presentation companion device 102 will be provided. Beginning with electronic devices configured to operate gaming applications, and turning now to FIG. 2, illustrated therein is one explanatory electronic device 200 configured in accordance with one or more embodiments of the disclosure.

Illustrated in FIG. 2 is one explanatory electronic device 200 in accordance with one or more embodiments of the disclosure. The electronic device 200 of FIG. 1 is a portable electronic device and is shown as a smartphone for illustrative purposes. However, it should be obvious to those of ordinary skill in the art having the benefit of this disclosure that other electronic devices may be substituted for the explanatory smart phone of FIG. 1. For example, the electronic device 200 could equally be a conventional desktop computer, palm-top computer, a tablet computer, a gaming device, a media player, or other device.

This illustrative electronic device 200 includes a display 201, which may optionally be touch-sensitive. Users can deliver user input to the display 201, which serves as a user interface for the electronic device 200.

In one embodiment, users can deliver user input to the display 201 of such an embodiment by delivering touch input from a finger, stylus, or other objects disposed proximately with the display 201. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 1 also includes a device housing 202. In one embodiment, the device housing 202 includes two housing members, namely, a first device housing 203 that is coupled to a second device housing 204 by a hinge 205 such that the first device housing 203 is pivotable about the hinge 205 relative to the second device housing 204 between a closed position and an axially displaced open position.

In other embodiments, such as was the case with the electronic device (101) of FIG. 1, the device housing 202 will be rigid and will include no hinge. In still other embodiments, the device housing 202 will be manufactured from a flexible material such that it can be bent and deformed. Where the device housing 202 is manufactured from a flexible material or where the device housing 202 includes a hinge 205, the display 201 can be manufactured on a flexible substrate such that it bends. In one or more embodiments, the display 201 is configured as a flexible display that is coupled to the first device housing 203 and the second device housing 204, spanning the hinge 205. Features can be incorporated into the device housing 202, including control devices, connectors, and so forth.

Also shown in FIG. 2 is an explanatory block diagram schematic 206 of the explanatory electronic device 200. In one or more embodiments, the block diagram schematic 206 is configured as a printed circuit board assembly disposed within the device housing 202 of the electronic device 200. Various components can be electrically coupled together by electrical conductors, or a bus disposed along one or more printed circuit boards.

The illustrative block diagram schematic 206 of FIG. 2 includes many different components. Embodiments of the disclosure contemplate that the number and arrangement of such components can change depending on the particular use case or application. Examples of such applications relevant to the methods described below include gaming applications. However, the electronic device 200 can support other applications as well such as content consumption applications. Examples of content consumption applications include video streaming applications, movie streaming applications, image viewing applications, and television show streaming applications. The electronic device 200 can also support user interaction applications, examples of which include productivity applications such as word processors and spreadsheets, and content creation applications. Accordingly, electronic devices configured in accordance with embodiments of the disclosure can include some components that are not shown in FIG. 1, and other components that are shown may not be needed and can therefore be omitted.

In one embodiment, the electronic device 200 includes one or more processors 207. In one embodiment, the one or more processors 207 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 206. Each of the application processor and the auxiliary processor(s) can be configured to process and execute executable software code to perform the various functions of the electronic device with which the block diagram schematic 206 operates. A storage device, such as memory 208, can optionally store the executable software code used by the one or more processors 207 during operation. In one or more embodiments, the executable software comprises at least one gaming application 223.

In this illustrative embodiment, the block diagram schematic 206 also includes a communication device 209 that can be configured for wired or wireless communication with one or more other devices or networks. The networks can include a wide area network, a local area network, and/or personal area network. The communication device 209 may also utilize wireless technology for communication, such as, but are not limited to, peer-to-peer or ad hoc communications such as HomeRF, Bluetooth and IEEE 802.11, and other forms of wireless communication such as infrared technology. The communication device 209 can include wireless communication circuitry, one of a receiver, a transmitter, or transceiver, and one or more antennas 210.

In one embodiment, the one or more processors 207 can be responsible for performing the primary functions of the electronic device with which the block diagram schematic 206 is operational. For example, in one embodiment the one or more processors 207 comprise one or more circuits operable with the display 201 to present presentation information to a user. The executable software code used by the one or more processors 207 can be configured as one or more modules 211 that are operable with the one or more processors 207. Such modules 211 can store instructions, control algorithms, and so forth.

Various sensors 214 can be operable with the one or more processors 207. One example of a sensor that can be included with the various sensors 214 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 207, to detect an object in close proximity with-or touching-the surface of the display 201 or the device housing 202 of the electronic device 200 by establishing electric field lines between pairs of capacitive sensors and then detecting perturbations of those field lines.

Another example of a sensor that can be included with the various sensors 214 is a geo-locator that serves as a location detector 215. In one embodiment, location detector 215 is able to determine location data when authenticating a user. Location can be determined by capturing the location data from a constellation of one or more earth orbiting satellites, or from a network of terrestrial base stations to determine an approximate location. The location detector 215 may also be able to determine location by locating or triangulating terrestrial base stations of a traditional cellular network, or from other local area networks, such as Wi-Fi networks.

Another example of a sensor that can be included with the various sensors 214 is an orientation detector 216 operable to determine an orientation and/or movement of the electronic device 200 in three-dimensional space. Illustrating by example, the orientation detector 216 can include an accelerometer, gyroscopes, or other device to detect device orientation. An accelerometer can be used as a motion detector 220 to detect motion of the electronic device 200 as well. Additionally, the accelerometer can be used to sense some of the gestures of the user, such as one talking with their hands, running, or walking. When a gaming application 223 is operating on the one or more processors 207, the orientation detector 216 and motion detector 220 can be used in tandem to control the operations of the gaming application 223.

The orientation detector 216 can determine the spatial orientation of an electronic device 200 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 200.

In one or more embodiments, the one or more sensors 214 comprise an image capture device 224. In one embodiment, the image capture device 224 comprises a two-dimensional imager configured to receive at least one image of a person within an environment 213 of the electronic device 200. In one embodiment, the image capture device 224 comprises a two-dimensional red-green-blue (RGB) imager. In another embodiment, the image capture device 224 comprises an infrared imager. Other types of imagers suitable for use as the image capture device 224 will be obvious to those of ordinary skill in the art having the benefit of this disclosure.

In one or more embodiments, the block diagram schematic 206 includes an audio input/processor 221. The audio input/processor 221 is operable to receive audio input from an environment 213 about the electronic device 200. The audio input/processor 221 can include hardware, executable code, and speech monitor executable code in one embodiment. The audio input/processor 221 can be operable with one or more predefined identification references stored in memory 208.

With reference to audio input, the predefined identification references can comprise representations of basic speech models, representations of trained speech models, or other representations of predefined audio sequences that are used by the audio input/processor 221 to receive and identify voice commands that are received with audio input captured by an audio capture device. In one embodiment, the audio input/processor 221 can include a voice recognition engine. Regardless of the specific implementation utilized in the various embodiments, the audio input/processor 221 can access various speech models stored with the predefined identification references to identify speech commands, languages being spoken, and other information.

The one or more processors 207 can perform filtering operations on audio input received by the audio input/processor 221. For example, in one embodiment the one or more processors 207 can filter the audio input into identifiable audio input, i.e., first audio input, and other audio input that is not identifiable, i.e., second audio input.

The electronic device 200 can include a system contextual information analyzer 218. The system contextual information analyzer 218 can include a face analyzer and an environmental analyzer. The face analyzer and/or environmental analyzer can be configured to process an image or depth scan of an object and determine whether the object matches predetermined criteria by comparing the image or depth scan to one or more predefined identification references stored in memory 208.

For example, the face analyzer and/or environmental analyzer can operate as an identification module configured with optical and/or spatial recognition to identify objects using image recognition, character recognition, visual recognition, facial recognition, color recognition, shape recognition, and the like. Advantageously, the face analyzer and/or environmental analyzer can be used as a facial recognition device to determine the identity of one or more persons detected within the environment 213 of the electronic device 200.

Other components 217 operable with the one or more processors 207 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 217 can also include proximity sensors. The proximity sensors fall in to one of two camps: active proximity sensors and “passive” proximity sensors. Either the proximity detector components or the proximity sensor components can be generally used for gesture control and other user interface protocols.

The other components 217 can optionally include a barometer operable to sense changes in air pressure due to elevation changes or differing pressures of the electronic device 200. The other components 217 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

The system contextual information analyzer 218 can include a context engine operable with the various sensors to detect, infer, capture, and otherwise determine persons and actions that are occurring in an environment 213 about the electronic device 200. For example, where included one embodiment of the context engine determines assessed contexts and frameworks using adjustable algorithms of context assessment employing information, data, and events. These assessments may be learned through repetitive data analysis. Alternatively, a user may employ a menu or user controls via the display 201 to enter various parameters, constructs, rules, and/or paradigms that instruct or otherwise guide the context engine in detecting multi-modal social cues, emotional states, moods, and other contextual information. The context engine can comprise an artificial neural network or other similar technology in one or more embodiments.

A gaming system 212 can perform gaming operations when a gaming application 223 is operating on the one or more processors 207. This can include presenting a gaming user interface 219 on the display 201 of the electronic device. The gaming system 212 can receive user input through the gaming user interface 219 and/or use the motion detector 220, location detector 215, orientation detector 216, or other sensors 214 of the electronic device 200 to control gaming operations of the gaming application 223.

In one or more embodiments, gaming system 212 is operable with the one or more processors 207. In some embodiments, the one or more processors 207 can control the gaming system 212. In other embodiments, the gaming system 212 can operate independently, delivering information gleaned from detecting multi-modal social cues, emotional states, moods, and other contextual information to the one or more processors 207. The gaming system 212 can receive data from the various sensors 214. In one or more embodiments, the one or more processors 207 are configured to perform the operations of the gaming system 212.

In one or more embodiments, working with the other components the gaming system 212 can cause the communication device 209 to query a content presentation companion device to determine whether the content presentation companion device supports a gaming mode of operation. In one or more embodiments, such a query occurs when the communication device 209 detects electrical communication with the content presentation companion device across a wireless electrical communication channel. In one or more embodiments, the query occurs when both the communication device 209 detects electrical communication with the content presentation companion device across the wireless electrical communication channel and a gaming application 223 is operating on the one or more processors 207.

Illustrating by example, in one or more embodiments the communication device 209 detects establishment of a wireless electrical communication channel with a content presentation companion device. The gaming system 212, in response to the gaming application 223 operating on the one or more processors 207 while the communication device 209 is communicating with the content presentation companion device across the wireless electrical communication channel, can cause the communication device 209 to query the content presentation companion device to determine whether the content presentation companion device supports the gaming mode of operation.

In one or more embodiments, the gaming system 212 determines whether the content presentation companion device supports the gaming mode of operation by extracting operating modes of the content presentation companion device from an extension of EDID data received by the communication device 209 form the content presentation companion device in response to the query. In other embodiments, the gaming system 212 determine whether the content presentation companion device supports the gaming mode of operation by parsing a product identification code received by the communication device 209 from the content presentation companion device in response to the query.

Illustrating by example, the gaming system 212 can parse the product identification code by transmitting an operating mode query comprising the product identification code to a remote electronic device (one example of which is a server or computer supported by the manufacturer of the content presentation companion device). Upon receiving a response comprising the operating modes, the gaming system 212 can determine whether the gaming mode of operation is supported.

As will be shown in subsequent figures, the gaming system 212 can cause the user interface of the electronic device 200 to indicate whether the content presentation companion device supports the gaming mode of operation. Illustrating by example, in some embodiments the gaming system 212 can cause the display 201 to present a prompt indicating whether the content presentation companion device supports the gaming mode of operation. In other embodiments, the gaming system 212 can cause an audio output to indicate whether the content presentation companion device supports the gaming mode of operation by delivering an audible announcement.

Where a prompt is presented, the prompt can instruct that the operating mode of the content presentation companion device be changed to the gaming mode of operation. In some embodiments, when the user interacts with the prompt, the gaming system 212 can cause the communication device 209 to transmit an instruction to the content presentation companion device over the wireless electrical communication channel instructing the content presentation companion device to transition to the gaming mode of operation. In other embodiments, the gaming system 212 can automatically cause the communication device 209 to transmit the instruction to the content presentation companion device over the wireless electrical communication channel instructing the content presentation companion device to transition to the gaming mode of operation in response to determining the content presentation companion device supports the gaming mode of operation.

In still other embodiments, when the gaming system 212 fails to determine whether the content presentation companion device supports the gaming mode of operation in response to the query, the gaming system 212 can cause the user interface to present indicia that gaming modes exist. These indicia can instruct the user to investigate whether the content presentation companion device that they are currently using supports such a mode, as well as to enable it if so. The indicia can even suggest that the person upgrade to another content presentation companion device that supports a gaming mode of operation if theirs does not, and so forth.

In one or more embodiments, the gaming system 212 also receives, via the communication device 209, an identifying communication from the content presentation companion device indicating whether a gaming mode of operation is supported. As noted above, in one or more embodiments the gaming system 212 can received an EDID file having an extension comprising an indication identifying whether the gaming mode of operation is supported in response to the gaming system 212 making the initial query.

In one or more embodiments, the gaming system 212 can cause a user interface of the electronic device 200, examples of which include the display 201 or the audio output devices included with the other components 217, to identify whether the gaming mode of operation is supported. Illustrating by example, in one or more embodiments the gaming system 212 can cause the one or more processors 207 to present a prompt on the display 201 of the electronic device 200 identifying whether the gaming mode of operation is supported.

In other embodiments, the gaming system 212 can identify the content presentation companion device port audibly. Using the loudspeakers of the other components 217, in one or more embodiments the gaming system 212 causes these loudspeakers to audibly announce whether the gaming mode of operation is supported by the content presentation companion device. Thus, in one or more embodiments the gaming system 212 causes the one or more processors 207 to cause an audio user interface to identify whether the content presentation companion device supports the gaming mode of operation by delivering an audible announcement.

In one or more embodiments, the gaming system 212 only identifies whether the content presentation companion device supports the gaming mode of operation when content presentation companion device is a large television. In other embodiments, the gaming system 212 only identifies whether the content presentation companion device supports the gaming mode of operation when a gaming application 223 is operating on the one or more processors 207 of the electronic device 200.

The inclusion of the gaming system 212 advantageously allows the electronic device 200 to determine whether it is connected to a content presentation companion device that supports a gaming mode of operation when communicating with the content presentation companion device via wireless electrical communication channel.

In one or more embodiments the gaming system 212 queries the content presentation companion device to identify its operating modes. Said differently, the gaming system 212 queries the content presentation companion device to find out which operating modes are supported.

In one or more embodiments, the content presentation companion device then transmits, using a modified EDID communication, an EDID extension identifying the operating modes that are supported. Specifically, in one or more embodiments the content presentation companion device transmits an EDID file structure in which the EDID extension flag is set. In one or more embodiments, this extension flag indicates that an additional 128-byte block of data describing increased capabilities of the EDID standard in accordance with embodiments of the disclosure, known as an “extension,” will be included with an identification of the supported operating modes.

In one or more embodiments, when this EDID extension is received, the gaming system 212 reads the identity of the operating modes causes the one or more processors 207 to present a prompt on the display 201 of the electronic device 200 that identifies whether a gaming mode of operation is one of these operating modes. This presentation of the operating modes on the display 201 allows the user to easily access and utilize this information to enable the gaming mode of operation at the content presentation companion device.

Thus, as shown in FIG. 2, the gaming system 212 can identify operating modes of a content presentation companion device with which the communication device 209 is electronically communicating across a wireless electrical communication channel when a gaming application 223 is operating on the one or more processors 207. The gaming system 212 an determine whether the operating modes include a gaming mode of operation and can cause the user interface (display 201 or audio output) to present indicia indicating whether the content presentation companion device supports the gaming mode of operation.

In one or more embodiments, the indicia comprise a control icon that, when actuated, causes the communication device 209 to transmit an instruction to the content presentation companion device causing the content presentation companion device to transition to the gaming mode of operation. In some embodiments, the gaming system 212 can automatically cause the communication device 209 to transmit an instruction to the content presentation companion device causing the content presentation companion device to transition to the gaming mode of operation. In still other embodiments, the indicia comprise instructions instructing the user to transition the content presentation companion device to the gaming mode of operation while the gaming application 223 is operating on the one or more processors 207.

A content presentation companion device integration manager 222 is operable to perform content redirection operations. In one or more embodiments, the content presentation companion device integration manager 222 allows the one or more processors 207 of the electronic device 200 to connect to a content presentation companion device such as a larger monitor, television, or other device having a larger screen. The content presentation companion device integration manager 222 then facilitates wireless streaming of content to the larger display of a content presentation companion device.

The inclusion of the content presentation companion device integration manager 222 allows the electronic device 200 to be used as a gaming user interface 219, mouse, trackpad, or other control device while content is being presented on the content presentation companion device. The content presentation companion device integration manager 222 can be used for presenting pictures, videos, television shows, or movies on the larger display of a content presentation companion device. Additionally, the content presentation companion device integration manager 222 can facilitate gaming, video conferences, and other content presentation tasks using the display of a content presentation companion device as well.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices configured in accordance with embodiments of the disclosure may include various other components not shown in FIG. 2 or may include a combination of two or more components or a division of a particular component into two or more separate components, and still be within the scope of the present disclosure.

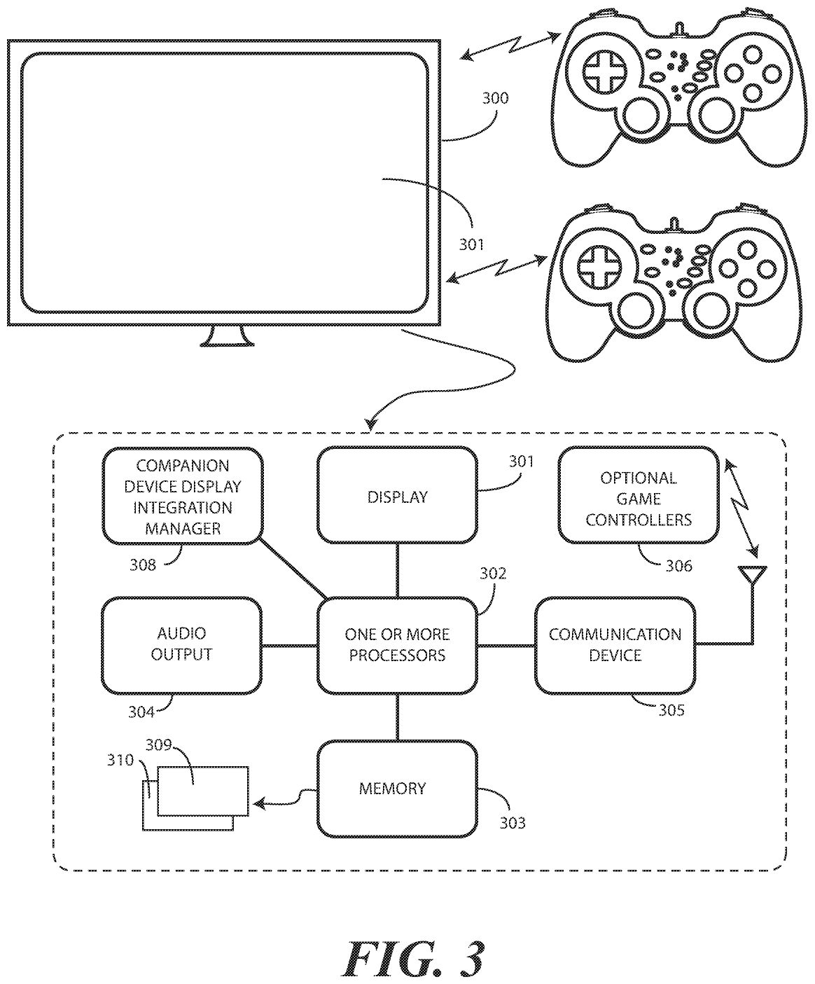

Turning now to FIG. 3, illustrated therein is one explanatory content presentation companion device 300 in accordance with one or more embodiments of the disclosure. In this illustrative embodiment, the content presentation companion device 300 comprises large television. In other embodiments, the content presentation companion device 300 can take other forms. Illustrating by example, the content presentation companion device 300 can be a color video monitor, a computer display, a laptop display, a tablet computer, gaming console that includes one or more game controllers 306, or a projector projecting content onto a screen. Other examples of content presentation companion devices will be obvious to those of ordinary skill in the art having the benefit of this disclosure. Regardless of configuration, in one or more embodiments the content presentation companion device 300 includes one or more processors 302, a display 301, a memory 303, an audio output 304, and a communication device 305 capable of wired or wireless communication with an electronic device such as the electronic device (101) of FIG. 1.

In one or more embodiments, when coupled by a wireless connection to such an electronic device (200), the content presentation companion device 300 can function as a primary display for the electronic device (200). The electronic device (200) can receive content from a terrestrial broadcast network, cable television network, Internet streaming service, or combinations thereof, and redirect this content to the content presentation companion device 300 using the content presentation companion device integration manager 308 since its display 301 is larger than the display of the electronic device (200). When a gaming application (223) is operating on one or more processors (207) of the electronic device (200), the output of the gaming application (223), examples of which include characters, scenes, and other depictions, can be presented on the display 301 of the content presentation companion device 300.

Effectively, the electronic device (200) is the source of content that could be presented on the display of the electronic device (200) but that is instead redirected to the content presentation companion device 300. This allows people within the environment of the electronic device (200) or content presentation companion device 300 to more easily see the content. In one or more embodiments, content flows from the electronic device (200) to the content presentation companion device 300 through the communication device 305.

As will be described in more detail below with reference to the subsequent methods and method steps, the content presentation companion device 300 can establish, with the communication device 305, a wireless electrical communication channel with the electronic device (200). Either automatically or, alternatively, in response to queries from the electronic device (200) transmit EDID file structure 309 or an EDID extension 310 of the EDID file structure 309 comprising one or more operating modes of the content presentation companion device 300.

Since the content presentation companion device 300 of FIG. 3 is a large television supporting a gaming mode of operation, the gaming mode of operation of the EDID extension 310 of the EDID file structure 309 would indicate this fact. The electronic device (200) could then perform any of the functions described above with reference to FIG. 2, examples of which include causing the content presentation companion device 300 to transition to the gaming mode of operation when a gaming application (223) is operating on the one or more processors (207) of the electronic device (200), presenting indicia identifying that the content presentation companion device 300 supports the gaming mode of operation, instructing the user to transition the content presentation companion device 300 to the gaming mode of operation, and so forth.

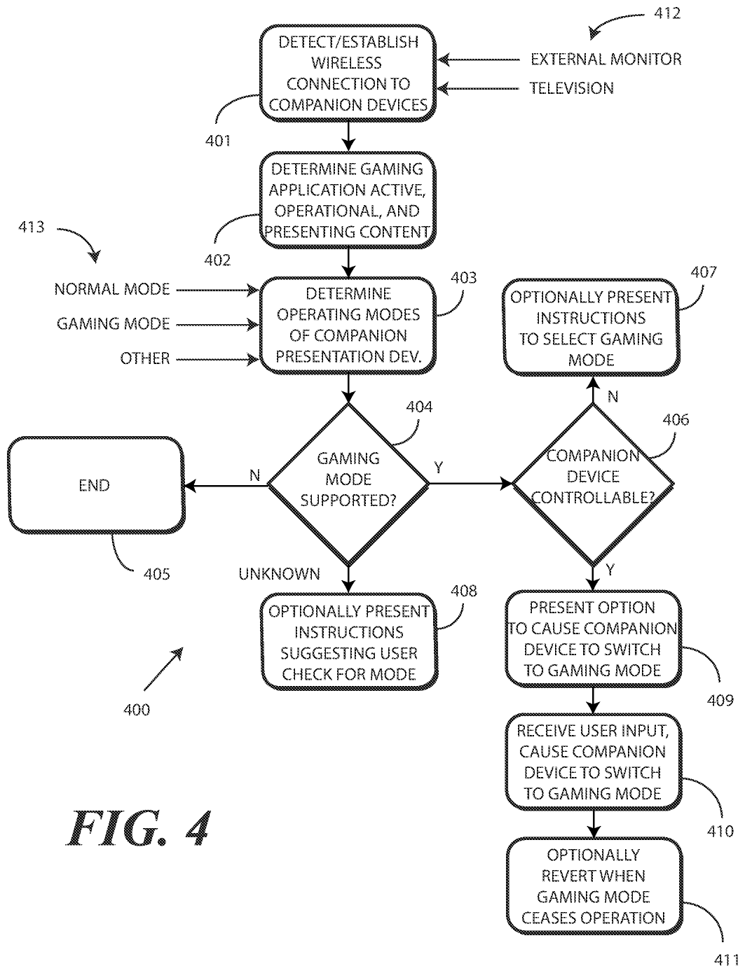

Turning now to FIG. 4, illustrated therein is one explanatory method 400 suitable for use with and/or in an electronic device in accordance with one or more embodiments of the disclosure. Beginning at step 401, a communication device of the electronic device detects the establishment of an electrical communication channel with content presentation companion device 412, examples of which include an external monitor or a television. In one or more embodiments, the electrical communication channel between the content presentation companion device 412 and the electronic device comprises a wireless electrical communication channel.

At step 402, the method optionally determines that a gaming application is actively operating on one or more processors of the electronic device. Step 402 can also include confirming that the gaming application is generating content for presentation to a user. The content can include a gaming control interface, characters of the game, scenes of the game, scores of the game, and so forth.

Step 403 then comprises querying, with a communication device, the content presentation companion device 412 for an identification of operating modes 413 available on the electronic device. Examples of the operating modes 413 include a normal mode of operation and a gaming mode of operation. Other operating modes will be obvious to those of ordinary skill in the art having the benefit of this disclosure.

Decision 404 determines whether a gaming mode of operation is supported on the content presentation companion device 412. In one or more embodiments, decision 404 occurs in response to a wireless communication device receiving EDID having an EDID extension comprising the operating modes 413 of the content presentation companion device 412. Illustrating by example, decision 404 can comprise extracting operating modes 413 of the content presentation companion device 412 from an extension of EDID received by the communication device from the content presentation companion device 412 in response to the query of step 403.

Decision 404 can also comprise parsing a product identification code from EDID received by the communication device from the content presentation companion device 412 in response to the query of step 403. This parsing operation can comprise transmitting an operating mode query to a remote electronic device, such as a server complex comprising information created by the manufacturer of the content presentation companion device 412 and receiving the operating modes 413 of the content presentation companion device 412 in response.

In one or more embodiments, if the content presentation companion device 412 does not support the gaming mode of operation, the process ends at step 405. In other embodiments, the method 400 can present prompt that one or both of inform the user that a gaming mode of operation exists and/or suggesting that the user look into purchasing a better content presentation companion device that supports the gaming mode of operation. The method 400 can also suggest that the user look to see whether any software or firmware updates are available for the content presentation companion device 412 that may enable a gaming mode of operation. Other suggestions that can be made when the user, sadly, is unable to avail himself of a gaming mode of operation will be obvious to those of ordinary skill in the art having the benefit of this disclosure.

Where the content presentation companion device 412 supports the gaming mode of operation, decision 406 determines whether the content presentation companion device 412 is controllable. Where the content presentation companion device 412 is controllable, step 409 comprises presenting, by one or more processors, indicia identifying that the content presentation companion device 412 supports the gaming mode of operation.

In one or more embodiments, the indicia comprise a control icon. Where it does, step 410 can comprise, in response to actuation of the control icon, causing a communication device to send an instruction instructing the content presentation companion device 412 to transition to the gaming mode of operation. Step 410 can also comprise removing the indicia when the one or more processors determine that the content presentation companion device 412 is operating in the gaming mode of operation.

In other embodiments, step 409 can comprise the one or more processors causing the display of either the electronic device upon which the gaming application is operating or the content presentation companion device 412 to indicate whether the content presentation companion device supports the gaming mode of operation by presenting a prompt on the display. Step 410 can the comprise automatically causing the content presentation companion device to transmit an instruction to the content presentation companion device 412 over a wireless electrical communication channel instructing the content presentation companion device to transition to the gaming mode of operation in response to determining that the content presentation companion device 412 supports the gaming mode of operation. Step 411 can then comprise causing the content presentation companion device 412 to revert to the normal mode of operation when operation of the gaming application on the electronic device ceases.

Where decision 406 determines that the content presentation companion device 412 is not controllable, step 407 can comprise causing a user interface of the electronic device upon which the gaming application is operating or of the content presentation companion device 412 to indicate whether the gaming mode of operation is supported. This can be done visually, such as by presenting information on a display, or audibly, such as by having a loudspeaker emit the information.

Step 407 can also comprise presenting an instructional prompt. Illustrating by example, step 407 can comprise presenting a prompt instructing a user to change the operating mode of the content presentation companion device 412 to the gaming mode of operation.

Where decision 404 fails to determine whether the content presentation companion device 412 supports the gaming mode of operation in response to the query of step 403, step 408 can comprise presenting indicia on the display indicating that gaming mode of operation exist. The indicia can also instruct the user to investigate whether their content presentation companion device 412 supports a gaming mode of operation and optionally, if not, whether they might like to upgrade to a content presentation companion device that does support the gaming mode of operation. The indicia may even present helpful suggestions of other content presentation companion devices that do support the gaming mode of operation, along with links or other purchasing options.

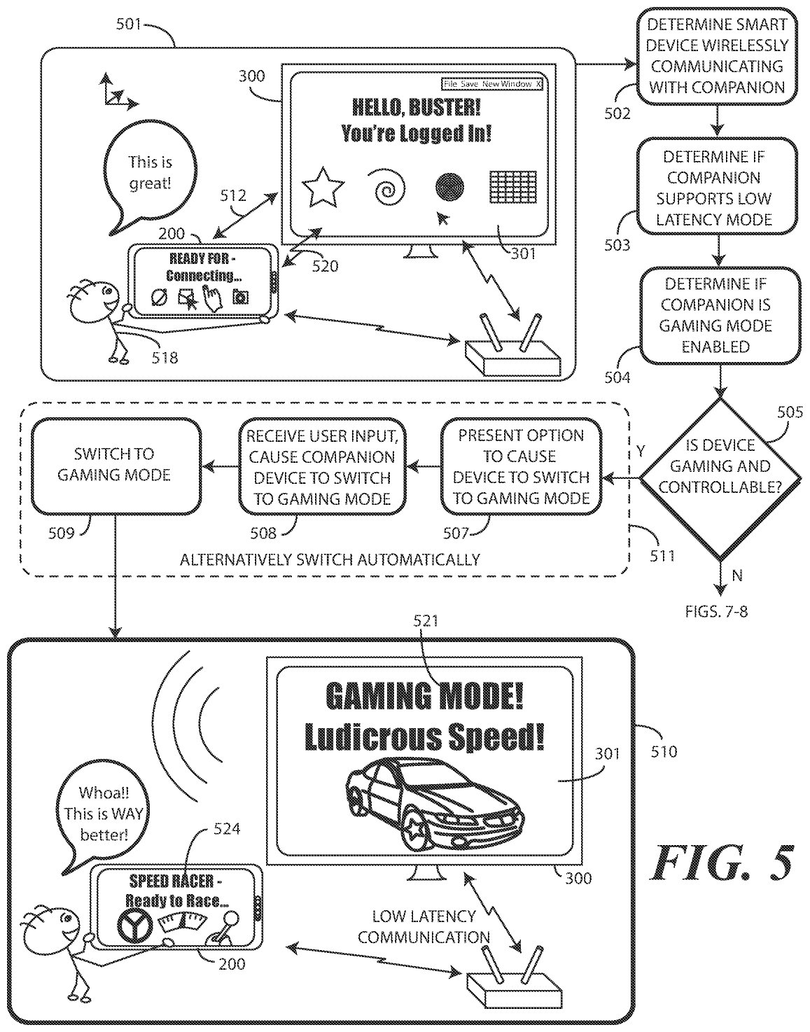

To further illustrate how the method 400 of FIG. 4 functions, a few use cases will be described. Turning now to FIG. 5, illustrated therein are one or more method steps illustrating how embodiments of the disclosure can be used to alert a user 518 to the fact that his content presentation companion device 300 supports a gaming mode of operation 521. Where the content presentation companion device 300 is controllable, an electronic device 200 operated by the user upon which a gaming application 524 is operating can automatically transition the content presentation companion device 300 to the gaming mode of operation when the gaming application 524 becomes active on one or more processors (207) of the electronic device 200. In other embodiments, the one or more processors (207) can present a prompt on either the display of the electronic device 200 or the display of the content presentation companion device 300 instructing the user to transition the content presentation companion device 300 to the gaming mode of operation 521.

Beginning at step 501, an electronic device 200 is again electronically in communication with the content presentation companion device 300. The content presentation companion device integration manager (222) of the electronic device 200 leverages the larger display 301 of the content presentation companion device 300 to present content.

In this illustrative embodiment a gaming application 524 is operating on the one or more processors (207) of the electronic device 200. At step 501, the communication device (209) of the electronic device 200 establishes a wireless electrical communication channel 520 with the content presentation companion device 300. The one or more processors (207) of the electronic device 200 can then cause the communication device (209) to deliver content 512 to the content presentation companion device 300 for presentation on the larger display 301 of the content presentation companion device 300.

The one or more processors (207) of the electronic device 200 determine that the electronic device 200 is electronically in communication with the content presentation companion device 300 by way of a wireless electrical communication channel 520 at step 502. At step 503, the one or more processors (207) of the electronic device 200 determine whether the content presentation companion device 300 supports a gaming mode of operation 521. This can be done in a variety of ways.

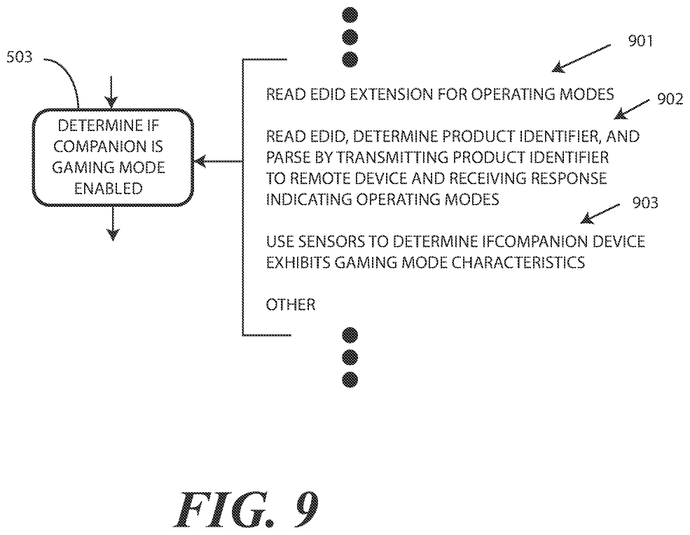

Turning briefly to FIG. 9, illustrated therein are some ways in which step 503 of FIG. 5 can be performed. As previously described, in one or more embodiments the content presentation companion device (300) delivers the identity of the operating modes of the content presentation companion device (412) using a modified EDID communication. In one or more embodiments, this modified EDID communication comprises the transmission of an EDID file structure (309) and an EDID extension (310). Accordingly, in one or more embodiments step 503 comprises extracting the operating modes from an EDID extension (310) to determine whether the content presentation companion device (300) supports the gaming mode of operation (521).

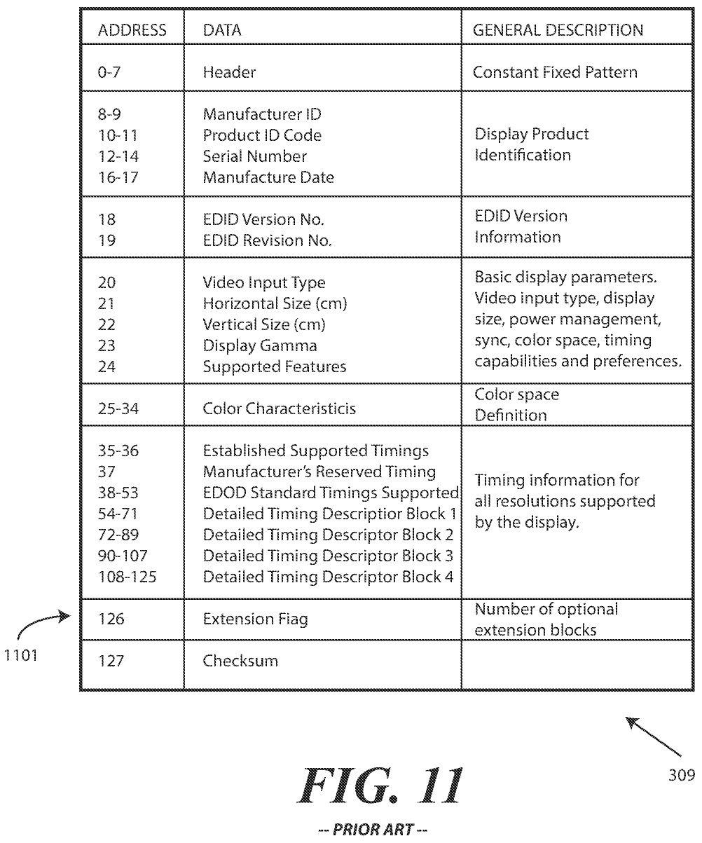

Turning briefly to FIG. 11, illustrated therein is an EDID file structure 309. The EDID file structure 309 is a standardized communication protocol that allows a display to inform a source as to the operating capabilities it possesses. Using the EDID file structure 309, a content presentation companion device can inform a source device regarding operating characteristics such as native resolution, display size, aspect ratio, color definition, and other supported features. The EDID file structure 309 can even identify the manufacturer and serial number of the content presentation companion device.

Communication of the EDID file structure 309 allows a source device to configure the content it delivers to the content presentation companion device without the user having to manually configure the same. Additionally, the EDID file structure 309 reduces the chance for the content being transmitted incorrectly from the source device to the content presentation companion device. Developed by the Video Electronic Standards Association (VESA), the EDID file structure 309 allows for far more information to be delivered from a content presentation companion device to a source device than, for example, having dedicated pins attempt to carry information using binary signals. In one or more embodiments.

The EDID file structure 309 defines a 128-byte data structure that includes manufacturer and operation-related data. As shown in FIG. 11, this information includes a vendor/product identification block, an EDID structure version and revision, basic display parameters and features, color characteristics, established timings, standard timing information, and detailed timing descriptions.

Relevant to embodiments of the disclosure, the EDID file structure 309 also allows for an extension flag 1101. The extension flag 1101, when set, indicates that an extension, which is an additional 128-byte block of data, will be included with the EDID file structure 309 to describe increased capabilities. Such an EDID extension is used in accordance with one or more embodiments of the disclosure.

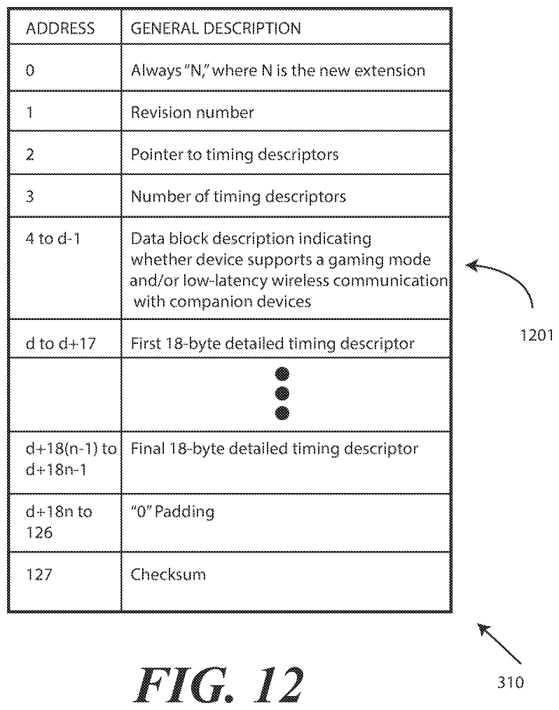

Turning now to FIG. 12, illustrated therein is one explanatory EDID extension 310 configured in accordance with one or more embodiments of the disclosure. As shown, the EDID extension 310 includes a payload field 1201 comprising the identity of the operating modes of the content presentation companion device. Accordingly, the payload field 1201 indicates whether a content presentation companion device supports a gaming mode of operation (521).

Turning now back to FIG. 9, step 503 can also comprise reading 901 the EDID file structure 309 to extract a product identification code, examples of which include the manufacturer and serial number of the content presentation companion device. Step 503 can then parse 902 this product identification code by sending the product identification code to a remote electronic device, examples of which include servers operated by the manufacturer, public information servers, service servers, content presentation companion device support servers, social media servers, and so forth, seeking a response regarding whether a particular manufacturer and serial number of the content presentation companion device support a gaming mode of operation (521). A response can be received thereafter indicating the same.

In still other embodiments, step 503 can comprise an electronic device determining 903. whether a gaming mode of operation (521) is active using one or more sensors. Illustrating by example, an image capture device might capture one or more images of the content presentation companion device to determine whether there is flicker or delay in response to user actuation target actuations occurring at the electronic device. Other techniques for using one or more sensors to determine whether the content presentation companion device is in a gaming mode of operation (521) will be obvious to those of ordinary skill in the art having the benefit of this disclosure.

Turning now back to FIG. 5, in one or more embodiments step 503 comprises receiving the EDID file structure (309) and EDID extension (310) having the payload field (1201) comprising the identity of the operating modes of the content presentation companion device 300. While EDID information is typically exchanged when the electronic device 200 is connected to the content presentation companion device 300, in one or more embodiments the modified EDID communication comprising the EDID file structure (309) and EDID extension (310) having the payload field (1201) comprising the identity of the operating modes of the content presentation companion device 300 is transmitted in response to a query from the electronic device 200. Accordingly, in one or more embodiments step 503 comprises one or more processors (207) of the electronic device 200 causing the communication device (209) to query the content presentation companion device 300 for the operating modes of the content presentation companion device 300.

In one or more embodiments, when the modified EDID communication is received, step 503 comprises one or more processors of the electronic device 200 reading the identity of the operating modes. Step 504 determines whether the gaming mode of operation 521 is enabled. This can be done using one or more sensors (214) of the electronic device 200 as previously described.

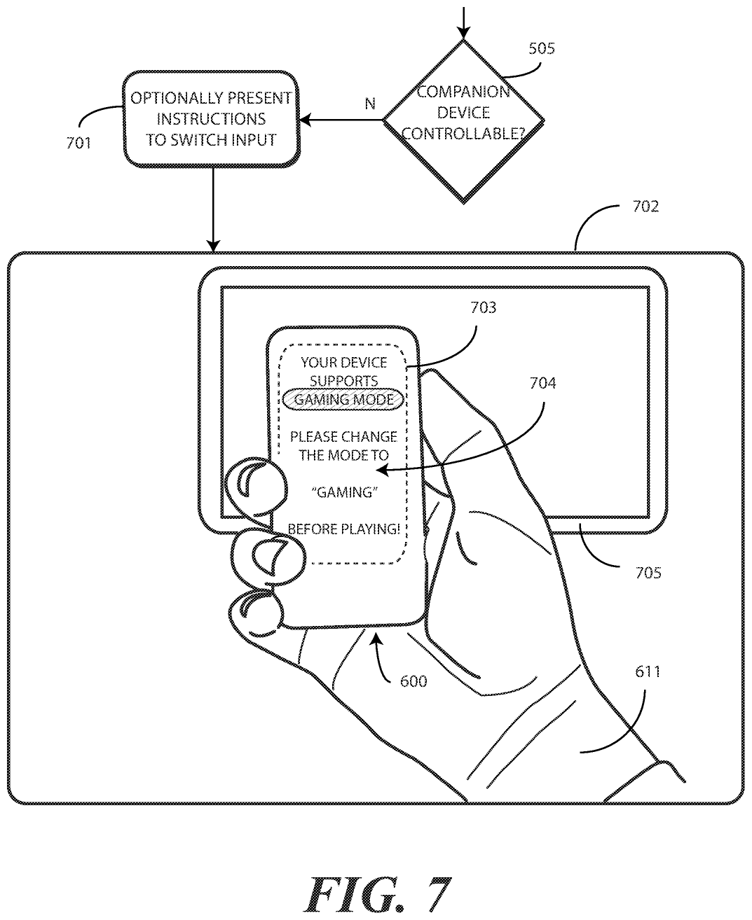

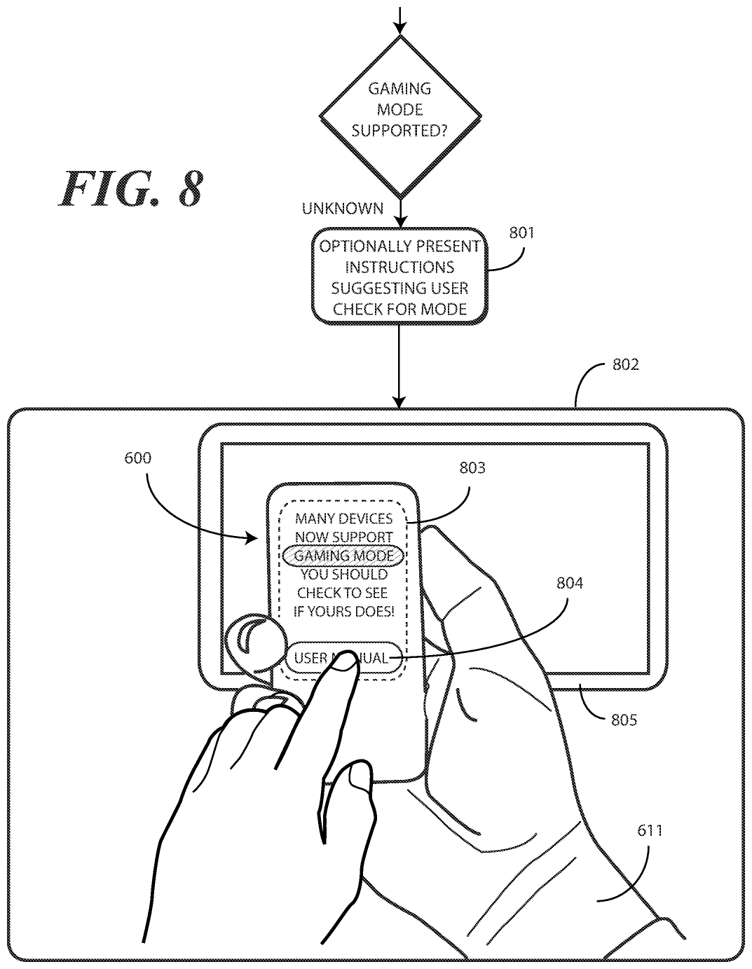

Decision 505 determines whether the content presentation companion device 300 is controllable. Where it is, steps 507,508,509 or, alternatively, step 511, can result in the content presentation companion device 300 transitioning to the gaming mode of operation 521. Otherwise, the method steps in FIG. 7 or 8 can be performed.

Steps 507,508,509 are a manual process for alerting the user 518 to the fact that the content presentation companion device 300 supports the gaming mode of operation 521. Step 511 is an automatic causing of the content presentation companion device 300 to transition to the gaming mode of operation 521 when the content presentation companion device 300 is controllable.

At step 507, one or more processors (207) of the electronic device 200, either on the display of the electronic device 200 or on the display 301 of the content presentation companion device 300, a prompt indicating whether the content presentation companion device 300 supports the gaming mode of operation 521. Step 508 then comprises receiving user input interacting with the prompt. Step 509 then comprises the one or more processors (207) of the electronic device 200, in response to the user input, causing the communication device (209) to transmit an instruction to the content presentation companion device 300 over the wireless electrical communication channel 520 instructing the content presentation companion device 300 to transition to the gaming mode of operation 521.

By contrast, step 411 automatically causes the communication device (209) of the electronic device 200 to transmit the instruction to the content presentation companion device 300 instructing the content presentation companion device 300 to transition to the gaming mode of operation 521 in response to step 504 determining that the content presentation companion device supports the gaming mode of operation 521.

In this example, the operating context is that of a gaming mode of operation. Moreover, the content presentation companion device 300 does indeed support the gaming mode of operation 521. As such, step 509 causes the content presentation companion device 300 to enter the gaming mode of operation 521. This allows the one or more processors (207) of the electronic device 200 to present the game on the display 301 of the content presentation companion device 300, as shown at step 510. Since the display of the electronic device 200 is now available, it is available for a gaming controller user interface to be presented to control the gaming content presented on the display 301 of the content presentation companion device 300.

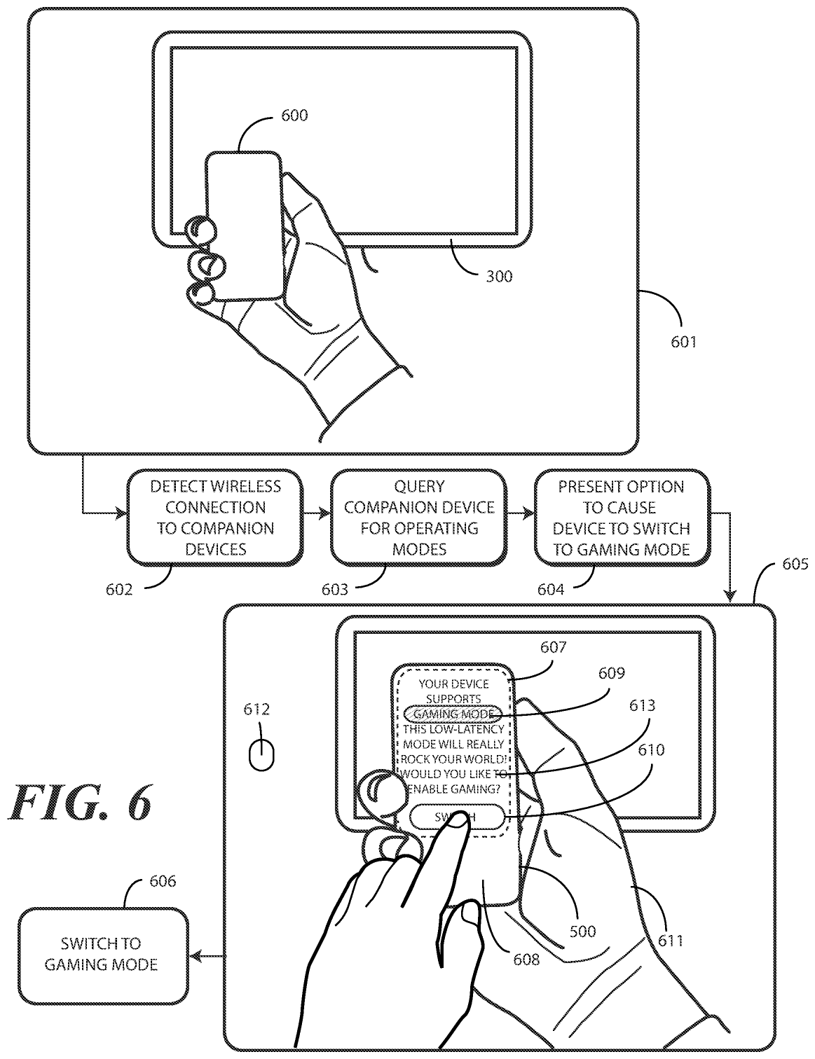

Turning now to FIG. 6, illustrated therein are one or more method steps in accordance with one or more embodiments of the disclosure. The method steps of FIG. 6 illustrate how a use-initiated transfer of a content presentation companion device 300 from a normal mode of operation to a gaming mode of operation can be performed akin to what was described above with reference to steps (507,508,509) of FIG. 5.

At step 601, an electronic device 600 configured in accordance with one or more embodiments of the disclosure establishes a wireless electrical communication channel with a content presentation companion device 300. The establishment of the wireless electrical communication channel with the content presentation companion device 300 is detected at step 602.

At step 603, a communication device of the electronic device 500 queries the content presentation companion device 300 for an identification of operating modes of the content presentation companion device. In one or more embodiments, step 603 comprises receiving a response to the query in the form of EDID data combined with an EDID extension identifying the operating modes of the content presentation companion device 300. One or more processors of the electronic device 500 can determine whether the content presentation companion device 300 supports a gaming mode of operation by extracting the operating modes from the EDID extension as previously described.

In this illustration, the content presentation companion device 300 does indeed support a gaming mode of operation. Accordingly, step 604 can comprise causing a user interface of the electronic device 500 to indicate whether the content presentation companion device 300 supports the gaming mode of operation. In this illustrative embodiment, as shown at step 605, this comprises presenting a prompt 607 on a display 608 of the electronic device 500. The prompt 607 indicates that a gaming mode of operation 609 is supported. The prompt 607 also includes a control icon 610. The control icon 610, when actuated, causes the communication device of the electronic device 500 to send an instruction 612 instructing the content presentation companion device 300 to transition to the gaming mode of operation 609.

The prompt 607 also includes indicia 613 explaining to the user 611 both that the content presentation companion device 300 supports the gaming mode of operation 609 and that switching to the gaming mode of operation 609 would dramatically improve the user's gaming experience. The indicia 613 of step 605 includes an instruction, in the form of a question, suggesting that it would be beneficial to transition the content presentation companion device 300 to the gaming mode of operation 609.

As shown at step 605, a user 611 is interacting with the control icon 610. Accordingly, step 606 comprises causing a wireless communication device of the electronic device 600 to transmit an instruction 612 to the content presentation companion device 300 causing the content presentation companion device 300 to transition to the gaming mode of operation 609.

The method steps of FIG. 6 work well when the content presentation companion device is controllable. However, embodiments of the disclosure contemplate that not every content presentation companion device will be controllable. In many situations, there is simply no other option but to have a user manually transition the content presentation companion device to the gaming mode of operation. Turning now to FIG. 7, illustrated therein is one example of how this can occur.

Beginning with decision 505 from FIG. 5, in this illustrative example decision 505 determines that the content presentation companion device 705 of this explanatory example is not controllable. Accordingly, step 701 comprises causing the user interface of the electronic device 600 to indicate this fact. As shown at step 702, in this illustrative embodiment this comprises presenting a prompt 703 that includes an instruction 704 instructing the user 611 to transition the operating mode of the content presentation companion device 705 to the gaming mode of operation. This instruction 704 both alerts the user 611 to the fact that the content presentation companion device 705 supports a gaming mode of operation and that the user 611 will need to enable the same to reap the benefits offered by the gaming mode of operation.

Turning now to FIG. 8, illustrated therein is the situation where a query from an electronic device 600 fails to determine whether the content presentation companion device 805 supports a gaming mode of operation. This can occur for a variety of reasons. The content presentation companion device 805 may be a legacy device incapable of communicating its capabilities to the electronic device 600. The content presentation companion device 805 may also simply be a legacy device not supporting the gaming mode of operation. Regardless, in one or more embodiments when this occurs step 801 comprises causing a user interface of the electronic device 600 to present indicia 803 indicating that gaming modes of operation exist. In this illustrative embodiment, as shown at step 802 the indicia 803 instructs investigation regarding whether the content presentation companion device 805 supports a gaming mode of operation. To assist the user 611 in determining this fact, the indicia 803 conveniently presents a link 804 to the user's manual of the content presentation companion device 805.

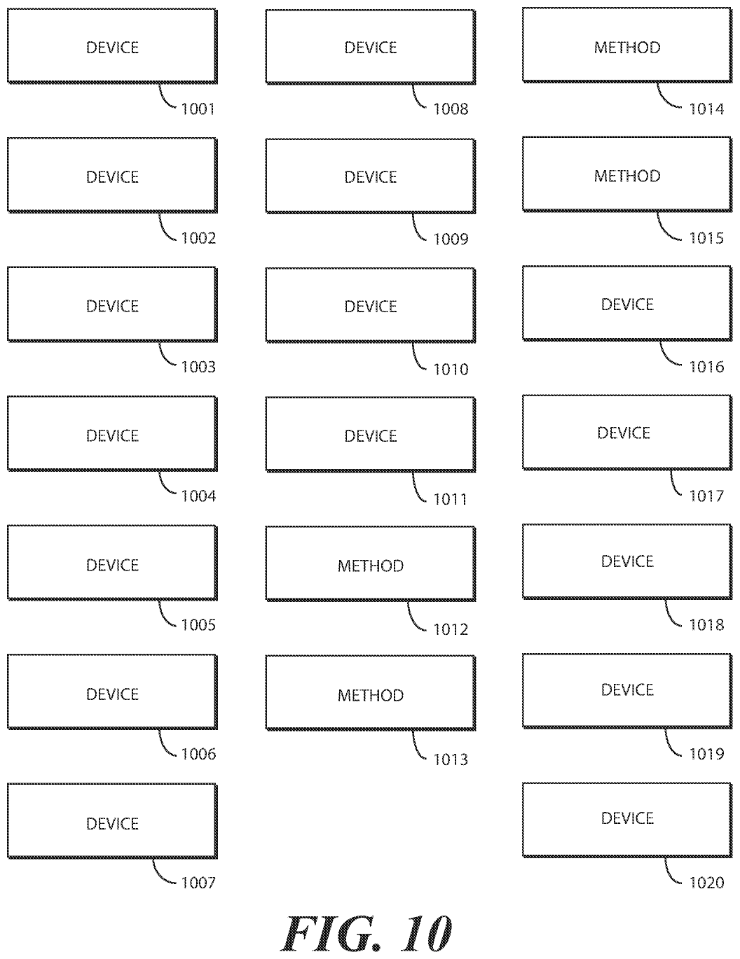

Turning now to FIG. 10, illustrated therein are various embodiments of the disclosure. The embodiments of FIG. 10 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, an electronic device comprises a communication device. At 1001, the communication device detects establishment of a wireless electrical communication channel with a content presentation companion device.

At 1001, the electronic device comprises one or more processors operable with the communication device. At 1001, the one or more processors cause, in response to a gaming application operating on the one or more processors while the communication device is communicating with the content presentation companion device across the wireless electrical communication channel, the communication device to query the content presentation companion device to determine whether the content presentation companion device supports a gaming mode of operation.

At 1002, the one or more processors of 1001 determine whether the content presentation companion device supports the gaming mode of operation by extracting operating modes of the content presentation companion device from an extension of EDID received by the communication device from the content presentation companion device in response to the query. At 1003, the one or more processors of 1001 determine whether the content presentation companion device supports the gaming mode of operation by parsing a product identification code from EDID received by the communication device from the content presentation companion device in response to the query.

At 1004, the one or more processors of 1003 parse the product identification code by transmitting an operating mode query comprising the product identification code to a remote electronic device. At 1004, the one or more processors receive operating modes of the content presentation companion device from the remote electronic device in response.

At 1005, the electronic device of 1001 further comprises a user interface. At 1005, the one or more processors cause the user interface to indicate whether the content presentation companion device supports the gaming mode of operation.

At 1006, the electronic device of 1001 further comprises an audio user interface. At 1006, the one or more processors cause the audio user interface to indicate whether the content presentation companion device supports the gaming mode of operation by delivering an audible announcement.

At 1007, the electronic device of 1001 further comprises a display. At 1007, the one or more processors cause the display to indicate whether the content presentation companion device supports the gaming mode of operation by presenting a prompt on the display.

At 1008, the prompt of 1007 instructs an operating mode of the content presentation companion device be changed to the gaming mode of operation. At 1009, the display of 1008 receives user input interacting with the prompt. At 1009, the one or more processors, in response to the user input, cause the communication device to transmit an instruction to the content presentation companion device over the wireless electrical communication channel instructing the content presentation companion device to transition to the gaming mode of operation.

At 1010, the one or more processors of 1001 automatically cause the communication device to transmit an instruction to the content presentation companion device over the wireless electrical communication channel. At 1010, the instruction instructs the content presentation companion device to transition to the gaming mode of operation in response to determining the content presentation companion device supports the gaming mode of operation.

At 1011, the electronic device of 1001 further comprises a user interface. At 1011, when the one or more processors fail to determine whether the content presentation companion device supports the gaming mode of operation in response to the query, the one or more processors cause the user interface to present indicia indicating that gaming modes of operation exist and instructing investigation regarding whether the content presentation companion device supports the gaming mode of operation.

At 1012, a method in an electronic device comprises establishing, with a communication device, a wireless electrical communication channel with a content presentation companion device. At 1012, the method comprises operating, with one or more processors of the electronic device, a gaming application.

At 1012, the method comprises querying, with the communication device, the content presentation companion device for an identification of operating modes. At 1012, where the content presentation companion device supports a gaming mode of operation, the method comprises one or both of causing, by the one or more processors, the content presentation companion device to transition to the gaming mode of operation and/or presenting, by one or more processors on a user interface, indicia identifying that the content presentation companion device supports the gaming mode of operation.

At 1013, the indicia of 1012 instruct the content presentation companion device be transitioned to the gaming mode of operation. At 1014, the indicia comprise a control icon causing, when actuated, the communication device to send an instruction instructing the content presentation companion device to transition to the gaming mode of operation. At 1015, the method of 1012 further comprises removing the indicia when the one or more processors determine the content presentation companion device is operating in the gaming mode of operation.

At 1016, an electronic device comprises a wireless communication device, a user interface, and one or more processors operable with the wireless communication device and the user interface. At 1016, the one or more processors identify operating modes of a content presentation companion device with which the wireless communication device is electrically communicating when a gaming application is operating on the one or more processors.

At 1016, the one or more processors determine whether the operating modes include a gaming mode of operation. At 1016, the operating modes cause the user interface to present indicia indicating the content presentation companion device supports the gaming mode of operation.

At 1017, the one or more processors of 1016 identify the operating modes of the content presentation companion device in response to the wireless communication device receiving EDID having an extension comprising the operating modes of the content presentation companion device. At 1018, the one or more processors of 1016 cause the wireless communication device to transmit an instruction to the content presentation companion device causing the content presentation companion device to transition to the gaming mode of operation.

At 1019, the indicia of 1016 comprise a control icon that, when actuated, causes the wireless communication device to transmit an instruction to the content presentation companion device causing the content presentation companion device to transition to the gaming mode of operation. At 1020, the indicia of 1016 instruct a user to transition the content presentation companion device to the gaming mode of operation while the gaming application is operating on the one or more processors.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. An electronic device, comprising:
a communication device, the communication device detecting establishment of a wireless electrical communication channel with a content presentation companion device; and
one or more processors operable with the communication device;
the one or more processors causing, in response to a gaming application operating on the one or more processors while the communication device is communicating with the content presentation companion device across the wireless electrical communication channel, the communication device to query the content presentation companion device to determine whether the content presentation companion device supports a gaming mode of operation.

2. The electronic device of claim 1, the one or more processors determining whether the content presentation companion device supports the gaming mode of operation by extracting operating modes of the content presentation companion device from an extension of extended display identification data (EDID) received by the communication device from the content presentation companion device in response to the query.

3. The electronic device of claim 1, the one or more processors determining whether the content presentation companion device supports the gaming mode of operation by parsing a product identification code from EDID received by the communication device from the content presentation companion device in response to the query.

4. The electronic device of claim 3, the one or more processors parsing the product identification code by transmitting an operating mode query comprising the product identification code to a remote electronic device and receiving operating modes of the content presentation companion device from the remote electronic device in response.

5. (canceled)

6. (canceled)

7. (canceled)

8. The electronic device of claim 1, further comprising changing an operating mode of the content presentation companion device to the gaming mode of operation.

9. (canceled)

10. (canceled)

11. (canceled)

12. (canceled)

13. (canceled)

14. (canceled)

15. (canceled)

16. An electronic device, comprising:
a wireless communication device;
a user interface; and
one or more processors operable with the wireless communication device and the user interface;
the one or more processors identifying operating modes of a content presentation companion device with which the wireless communication device is electrically communicating when a gaming application is operating on the one or more processors, determining whether the operating modes include a gaming mode of operation, and causing the user interface to present indicia indicating the content presentation companion device supports the gaming mode of operation.

17. The electronic device of claim 16, the one or more processors identifying the operating modes of the content presentation companion device in response to the wireless communication device receiving EDID having an extension comprising the operating modes of the content presentation companion device.

18. The electronic device of claim 17, the one or more processors causing the content presentation companion device to transition to the gaming mode of operation.

19. (canceled)

20. (canceled)
